(19) United States
(12) Patent Application Publication
(10) Pub. No.: US 2015/0130165 A1
(43) Pub. Date: May 14, 2015

(54) Towing Apparatus

(71) Applicant: William Eckert, Wesley Chapel, FL (US)

(72) Inventor: William Eckert, Wesley Chapel, FL (US)

(21) Appl. No.: 14/079,673

(22) Filed: Nov. 14, 2013

(51) Int. Cl. B60D 1/60

(52) U.S. Cl. CPC B60D 1/60
USPC 280/480.1; 280/495

(57) ABSTRACT

A towing apparatus that is operable to receive and store a tow rope and is further configured to protect the tow rope when not deployed for use. The towing apparatus further includes a shank that is configured to couple with a receiver of a conventional frame hitch. A base plate is secured to the shank wherein the base plate has hingedly coupled thereto a body having a plurality of walls forming an interior volume. A shackle is secured to the base plate on the opposing side from the shank and is configured to receive an end of a tow rope. A pair of fasteners are operable to maintain the body in a closed position so as to protect a tow rope secured to the base plate. A strap is further included being operable to retain a tow rope in a stored position.

### FIELD OF THE INVENTION

The present invention relates generally to towing devices, more specifically but not by way of limitation, a towing apparatus that is operably coupled to a frame hitch of a motor vehicle that includes a storage compartment having an integrated towing strap therein.

### BACKGROUND

Tow straps are utilized in a wide variety applications to either tow or remove motor vehicles from a first location to a second location. Whether removing a vehicle that has become stuck in undesirable terrain such as mud or to assist in the transportation of a motor vehicle that is mechanically inoperable, it is common for a tow vehicle to utilize a tow strap or similar device to operably couple to the disabled vehicle. Conventional tow straps are often made of woven nylon and further include fasteners such as but not limited to hooks.

Currently, most vehicles that either routinely or only occasionally deploy a tow strap to tow a second vehicle either store the strap within a compartment of the vehicle such as the trunk or bed of a truck. Additionally, tow straps can be stored in various locations and retrieved only when needed. Preserving the integrity of the tow strap is important as damage to the tow strap during storage can result in the failure of the tow strap during use. Presently trucks and vehicles such as military vehicles store tow straps in existing compartments that do not provide optimum protection as well as effective deployment when needed. Numerous different configurations can exist for storing tow straps to vehicles that can include surroundably mounting to a bumper or portion of the frame. Furthermore, it is common for the tow strap to be stored in such a manner that neither end thereof is operably secured to the vehicle at all times. The disorderly storage of the tow straps results in ineffective deployment as well as potential damage to the tow strap.

Accordingly there is a need for a towing apparatus that is operably coupled to a vehicle that provides a storage compartment for storing an integrated tow strap when not in use and further is configured for rapid deployment of the tow strap upon requirement thereof.

### SUMMARY OF THE INVENTION

It is the object of the present invention to provide a towing apparatus that is operable to be releasably secured to a tow vehicle that includes an integrated tow strap operable to be coupled to a second vehicle.

Another object of the present invention is to provide a towing apparatus that is releasably secured to a tow vehicle that includes a shank operable to mateably secure to a frame hitch of the tow vehicle.

A further object of the present invention is to provide a towing apparatus that is releasably secured to a tow vehicle having an integrated tow strap wherein the towing apparatus includes a storage compartment having an interior volume operable to receive the tow strap.

An additional object of the present invention is to provide a towing apparatus that is releasably secured to a tow vehicle wherein the storage compartment includes an outer wall that is hingedly secured so as to provide access to the tow strap disposed within the interior volume of the storage compartment.

Still a further object of the present invention is to provide a towing apparatus having an integrated towing strap wherein the towing strap includes an end that is operably coupled to the tow vehicle.

Another object of the present invention is to provide a towing apparatus releasably secured to a tow vehicle having a storage compartment with an integrated tow strap disposed therein wherein the outer wall of the storage compartment is manufactured from a formable material.

Yet an additional object of the present invention is to provide a towing apparatus that is releasably secured to a vehicle having an integrated tow strap that further includes a fastener disposed within the interior volume of the storage compartment that is operable to receive a first end of the tow strap.

A further object of the present invention is to provide a towing apparatus that is releasably secured to a tow vehicle that includes a storage compartment having an integrated tow strap mounted therein that further includes a mounting strap facilitating the orderly storage of the integrated tow strap.

An additional object of the present invention is to provide a towing apparatus that is releasably secured to a tow vehicle wherein the storage compartment is manufactured from a durable resilient crush-resistant material that allows the vehicle to which it is secured to be pushed by another vehicle and avoid damage to the storage compartment.

Still another object of the present invention is to provide a towing apparatus having a storage compartment and an integrated tow strap disposed therein that is operable to mateably coupled with a plurality of sizes of frame hitches.

To the accomplishment of the above and related objects the present invention may be embodied in the form illustrated in the accompanying drawings. Attention is called to the fact that the drawings are illustrative only. Variations are contemplated as being a part of the present invention.

### BRIEF DESCRIPTION OF THE DRAWINGS

A more complete understanding of the present invention may be had by reference to the following Detailed Description when taken in conjunction with the accompanying Drawings wherein:

FIG. 1 is a side view of the preferred embodiment of the present invention in its closed position; and

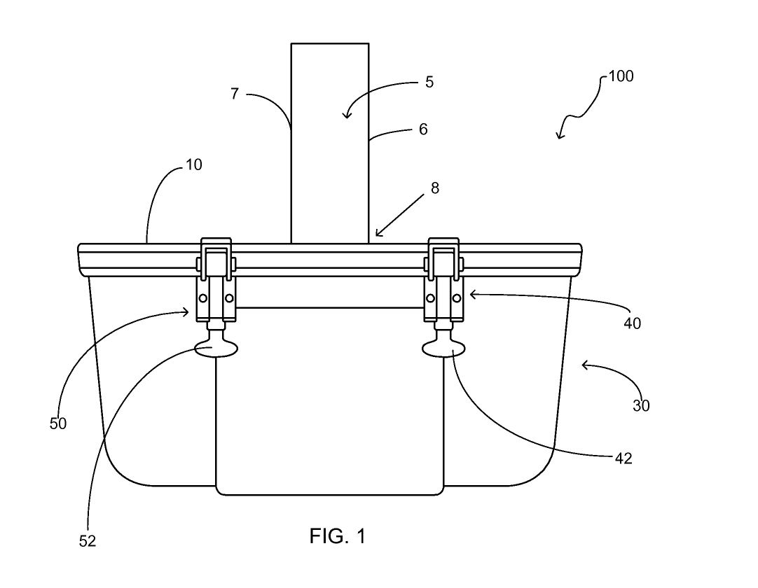

FIG. 2 is a perspective view of the preferred embodiment of the present invention in an open position;

FIG. 3 is a front view of the preferred embodiment of the present invention in its open position; and

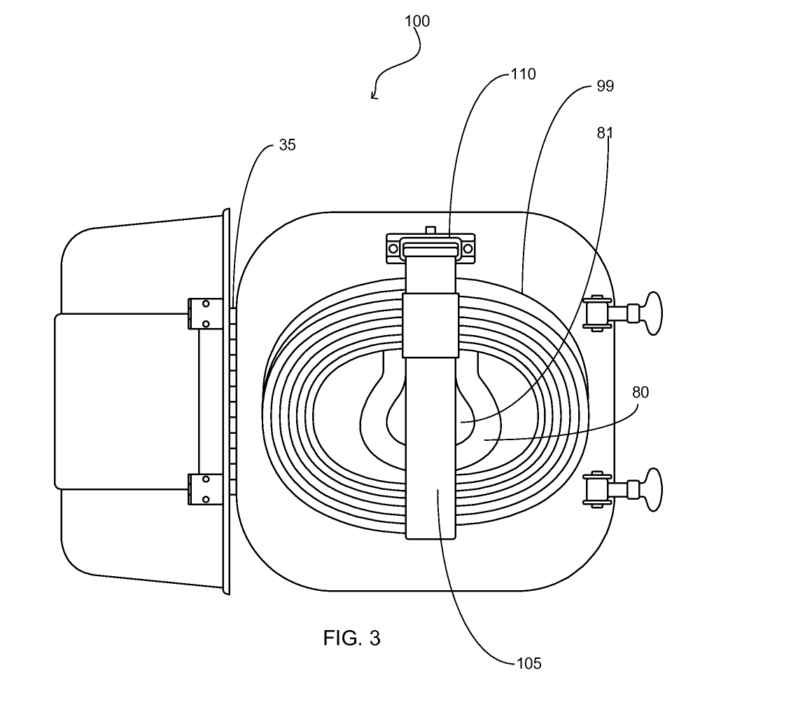

FIG. 4 is a perspective view of the preferred embodiment of the present invention coupled to an exemplary tow vehicle.

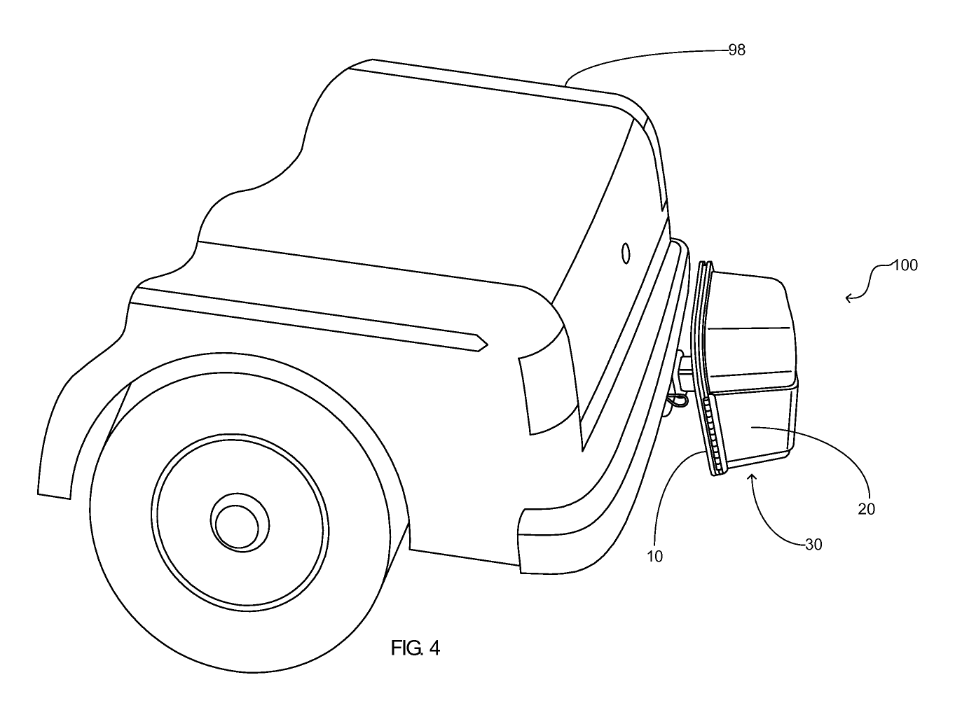

### DETAILED DESCRIPTION

Referring now to the drawings submitted herewith, wherein various elements depicted therein are not necessarily drawn to scale and wherein through the views and figures like elements are referenced with identical reference numerals, there is illustrated a towing apparatus 100 constructed according to the principles of the present invention.

Referring to the drawings herein, the towing apparatus 100 includes a shank 5 that is generally rectangular in manner and manufactured from a suitable durable material such as but not limited to metal. The shank 5 is configured to mateably engage with a receiver of a conventional frame hitch secured to a vehicle. It is contemplated within the scope of the present invention that the shank 5 could be manufactured in several different sizes in order to accommodate different size receivers of conventional frame hitches. While not illustrated herein the shank 5 includes apertures on the side walls 6,7 thereof in order to accommodate a conventional fastening pin or similar keeper so as to be releasably coupled with the receiver of a conventional frame hitch.

Secured to the second end 8 of the shank 5 is the base plate 10. The base plate 10 is generally square in shape having rounded corners and is manufactured from a suitable durable material such as but not limited to metal. The base plate 10 is secured to the second end 8 of the shank 5 utilizing suitable durable techniques such as but not limited to welding. While no particular thickness is required for the base plate 10 good results have been achieved by utilizing a base plate 10 that is approximately 5/16 inch in thickness. Additionally, while no particular size for the base plate 10 is required, good results have been achieved utilizing a base plate 10 that is approximately 12.5 inches by 12.5 inches. This size facilitates easy portability while providing sufficient space to store the tow rope 99.

Hingedly secured to the base plate 10 is the body 20. The body 20 includes a plurality of integrally formed walls 21 that are operable to form an interior volume 24. The body 20 is operably coupled to the base plate 10 so as to form a storage compartment 30. The body 20 includes perimeter edge 127 that is formed such that when adjacent the base plate 10 the perimeter edge 127 at least partially overlaps edge 131 of the base plate 10 so as to substantially inhibit debris from penetrating the interior volume 24. The body 10 is manufactured to be of mateable size with the base plate 10 and is hingedly secured to the base plate 10 with hinge 35. The hinge 35 is a conventional piano style hinge and it is contemplated within the scope of the present invention that the hinge 35 could be numerous different styles of low profile style hinges. The body 20 is manufactured from a durable resilient material such as but not limited to rubber. The resilient material of the body 20 is an important feature in order to prevent the body 20 from being compromised in particular applications. By way of example but not by way of limitation, in a situation where an exemplary vehicle 98 is being pushed by another motor vehicle and the towing apparatus 100 is operably coupled to the exemplary vehicle 98, the body 20 being manufactured from a resilient durable material will substantially avoid deformation. This is desirable within the scope of the present invention in order to prevent damage to the body 20 that would compromise the capacity of the interior volume 24 that could inhibit the body 20 from being moved to its first closed position.

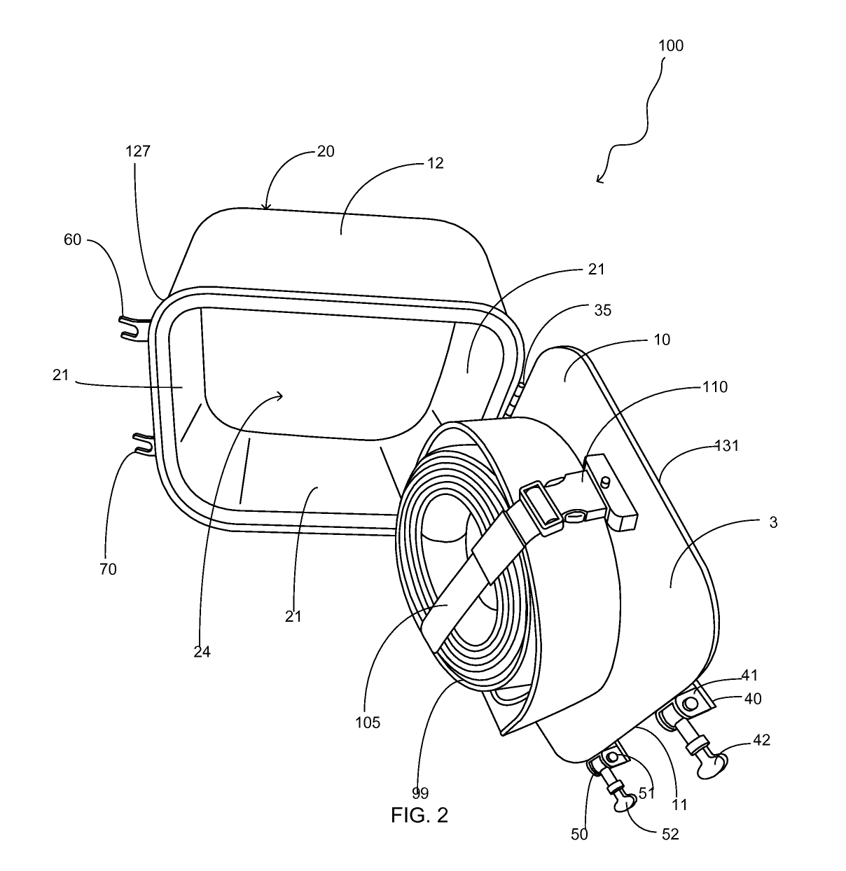

Secured to the lateral edge 11 of the base plate 10 are a first fastener 40 and a second fastener 50. The first fastener 40 and second fastener 50 are secured to the base plate 10 utilizing suitable durable techniques. First fastener 40 and second fastener 50 include brackets 41, 51 respectively. The brackets 41, 51 are manufactured from a suitable durable material such as metal and are operable coupled to keepers 42, 52 respectively. Keepers 42, 52 are elastic in manner so as to bias the body 20 in its closed position subsequent the keepers 42, 52 being operably engaged with clips 60, 70 respectively. The body 20 is moved to its open position as shown herein in FIG. 2 by disengaging keepers 42, 52 from clips 60, 70. The use of an elastic material for keepers 42,52 provides advantages for rapid transitioning between the body's 20 first closed position and second open position. While a preferred first fastener 40 and second fastener 50 have been disclosed herein, it is contemplated within the scope of the present invention that numerous styles of mechanical fasteners could be utilized to secure the body 20 in its closed position. Additionally, while a first fastener 40 and second fastener 50 have been discussed herein, it is contemplated within the scope of the present invention that as few as one fastener or more than two fasteners could be utilized to secure the body 20 in its closed position.

Secured to the base plate 10 adjacent to the interior surface 3 is shackle 80. The shackle 80 is manufactured from a suitable durable materials such as but not limited to metal and includes opening 81 operable to facilitate coupling with an end of tow rope 99. The shackle 80 is secured to the base plate 10 utilizing suitable durable techniques such as but not limited to a bolt and nut. The shackle 80 is hingedly configured so as to extend to a position such that it is substantially perpendicular to the base plate 10 subsequent the tow rope 99 being deployed and engaged with an object for tow. Those skilled in the art will recognize that numerous different sizes of shackles 80 could be utilized wherein each different size shackle 80 has a different weight capacity rating. While no specific size shackle 80 is required, good results have been achieved by utilizing a shackle 80 that is rated fro at least 7500 pounds.

Mounted to the base plate 10 is tow rope 99. The tow rope 99 is a conventional tow rope/strap having a first end and a second end wherein the first end is operably coupled with the shackle 80 and the second end is utilized to couple with an object that needs to be towed. It is preferred within the scope of the present invention that the tow rope 99 is a nylon tow strap as this facilitates the ability to store within the storage compartment 30 a longer tow rope 99. Those skilled in the art will recognize that the tow rope 99 could be in the form of a conventional rope or strap and accomplish the desired objective discussed herein. The tow rope 99 is secured against the base plate 10 when not in use with strap 105. Strap 105 is a conventional nylon and/or elastic strap having one end secured to the base plate 10 utilizing suitable durable techniques and a second end 107 releasbly secured to the base plate 10 tiling buckle 110. The buckle 110 is a conventional side release parachute buckle having a mateable portion secured to the second end 107 of the tow rope 99. Those skilled in the art will recognize that numerous different types of straps and/or fasteners could be utilized to store the tow rope 99 in its first position within the storage compartment 30. The storage compartment 30 functions to ensure the integrity of the tow rope 99 is maintained by substantially eliminating contact with weather and other environmental elements when stored in its first position.

Referring to the drawings herein, a description of the operation of the towing apparatus 100 is as follows. In use, the towing apparatus 100 is operably coupled to an exemplary vehicle 98 wherein the exemplary vehicle includes a conventional frame hitch. The shank 5 is coupled with a receiver of the conventional frame hitch and releasably secured therein. Upon requirement of an application wherein the tow rope 99 needs to be deployed, the keeper 42,52 are released from clips 60, 70. The body 20 is subsequently hinged to its second open position so as to provide access to the tow rope 99. Buckle 110 is released in order to facilitate deployment of the tow rope 99. The tow rope 99 includes an end that is operable secured to shackle 80. The distal end of the tow rope 99 from the shackle 80 is secured to an object requiring a tow. Ensuing the towing of the desired object, the tow rope 99 is stored adjacent to the base plate 10 and secured in its stored position with strap 105. The body 20 is moved back to its closed position and biased against the base plate 10 utilizing the first fastener 40 and second fastener 50 as discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A towing apparatus operable to be releasably secured to a tow vehicle comprising:
a shank;
a storage compartment, said storage compartment including a plurality of walls forming an interior volume, said storage compartment further including a base plate, said base plate being secured to said shank, said base plate being perpendicular to said shank, said storage compartment being hingedly to said base plate, said storage compartment having a first position and a second position wherein in said second position said storage compartment is hinged away from said base plate; and
a tow rope, said tow rope being disposed within the interior volume of said storage compartment and;
wherein said storage compartment is manufactured from a resilient material so as to avoid permanent deformation if subjected to compression forces.

2. The towing apparatus as recited in claim 1, and further including a shackle, said shackle operably secured to said base plate, said shackle configured to receive an end of said tow rope.

3. The towing apparatus as recited in claim 2, and further including at least one fastener, said at least one fastener being secured to said base plate, said at least one fastener operable to secure said portion in said first position.

4. The towing apparatus as recited in claim 3, and further including a strap, said strap having a first end and a second end, said strap being operably secured to said base plate, said strap operable to secure said tow rope in position such that the tow rope is adjacent to said base plate and within the interior volume of said storage compartment.

5. The towing apparatus as recited in claim 4, and further including at least on clip, said clip being secured to said portion, said clip operable to couple with said at least one fastener.

6. The towing apparatus as recited in claim 5, wherein said second end of said strap includes a buckle, said buckle operable to facilitate the releasable securing of said second end of said strap.

7. The towing apparatus as recited in claim 6, wherein said portion of said storage compartment is formed from rubber.

8. A towing apparatus operable to be releasably secured to a motor vehicle wherein the towing apparatus functions to protect a tow rope when not in use comprising:
a shank, said shank having a first end and a second end, said shank configured to be mateably coupled with a frame hitch,
a base plate, said base plate being secured to said second end of said shank, said base plate being planar in manner and perpendicular to said shank;
a body, said body having a plurality of integrally formed walls forming an interior volume, said body being hingedly secured to said base plate, said body having a first position and a second position, said body in said first position being biased against said base plate so as to form a storage compartment, said body being manufactured from a resilient rubber, said body including a perimeter edge wherein said perimeter edge is operable to overlap said base plate; and
a shackle, said shackle being secured to said base plate, said shackle disposed within the storage compartment.

9. The towing apparatus as recited in claim 8, and further including at least one fastener, said at least one fastener operable to secure said body adjacent to said base plate, said fastener further including an elastic portion, said elastic portion operable to maintain a bias force operable to retain said body in said first position.

10. The towing apparatus as recited in claim 9, and further including a tow rope said tow rope being stored adjacent to said base plate.

11. The towing apparatus as recited in claim 10, and further including a strap, said strap having a first end and a second end, said strap operable to secure said tow rope against said base plate.

12. The towing apparatus as recited in claim 11, and further including at least one clip, said at least one clip being secured to said body, said at least one clip configured to mateably secure with said elastic portion of said fastener.

13. The towing apparatus as recited in claim 12, wherein said base plate is at least 5/16 of an inch in thickness.

14. (canceled)

15. A towing apparatus operable to be releasably secured to a conventional frame hitch of a motor vehicle wherein the towing apparatus functions to protect a tow rope when not in use comprising:
a shank, said shank having a first end and a second end, said shank being rectangular in shape, said shank configured to mateably engage with a receiver of a conventional frame hitch;
a base plate, said base plate being secured to said second end of said shank; said base plate being planar in manner and square in shape having rounded corners, said base plate being perpendicular to said shank, said base plate having a first side and a second side wherein said second side is proximate said shank;
a body, said body having a plurality of integrally formed walls being shaped to form an interior volume, said body being of similar size and shape as said base plate, said body having a first edge and a second edge, said body being hingedly secured to said base plate along said first edge, said body having a first position and a second position, said body being manufactured from a resilient rubber so as to avoid deformation subsequent to being subjected to compression forces, said body having a perimeter edge, said perimeter edge operable to overlap said base plate;
at least one fastener, said at least one fastener being secured to said base plate, said at least one fastener further including an elastic portion, said at least one fastener operable to maintain said body in said first position;
a shackle, said shackle being hingedly mounted to said base plate, said shackle being mounted adjacent to said first side of said base plate, said shackle including an opening for receiving an end of a tow rope; and
wherein said body and said base plate are operable to form a storage compartment when said body is in said first position wherein the storage compartment is operable to receive and retain a tow rope.

16. (canceled)

17. The towing apparatus as recited in claim 15, and further including at least one clip, said at least one clip being secured to said body proximate said second edge, said at least one clip operable to couple with the elastic portion of said at least one fastener.

18. The towing apparatus as recited in claim 17, and further including a strap, said strap having a first end and a second end, said first end of said strap being secured to said first side of said base plate, said second end of said strap being configured to be releasably secured to said second side of said base plate.

19. The towing apparatus as recited in claim 18, wherein said second end of said strap further includes a buckle, said buckle configured to releasably secure said second end of said strap to said first side of said base plate.

20. The towing apparatus as recited in claim 19, wherein said base plate is approximately 5/16 of an inch in thickness and approximately 12 inches by 12 inches.
